(19) United States
(12) Patent Application Publication
(10) Pub. No.: US 2007/0279634 A1
(43) Pub. Date: Dec. 6, 2007

(54) Label-free grating-based surface plasmon resonance sensor

(76) Inventors: Russell W. Gruhlke, Santa Clara, CA (US); Susan Hunter, Fort Collins, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/443,074

(22) Filed: May 31, 2006

(51) Int. Cl. G01N 21/55

(52) U.S. Cl. 356/445

(57) ABSTRACT

A surface plasmon resonance sensor includes a conducting grating having an effective periodicity that varies with an azimuthal angle of a light ray incident on the conducting grating, thereby varying a surface plasmon resonance condition.

### BACKGROUND OF THE INVENTION

A grating-based surface plasmon resonance sensor detects a change in a sample by detecting a change in a surface plasmon resonance condition resulting from a change in the index of refraction of the sample, and thus does not require any fluorescent or other labeling of the sample. Accordingly, a grating-based surface plasmon resonance sensor is a label-free sensor.

### SUMMARY OF THE INVENTION

The invention relates to a surface plasmon resonance sensor including a conducting grating having an effective periodicity that varies with an azimuthal angle of a light ray incident on the conducting grating, thereby varying a surface plasmon resonance condition.

### BRIEF DESCRIPTION OF THE DRAWINGS

Embodiments in accordance with the invention are described below in conjunction with the accompanying drawings of which:

FIG. 1 shows a surface plasmon resonance sensor in accordance with the invention;

FIG. 2 shows a graph of energy versus wavenumber showing a relationship between light radiative states or plane wave states lying within a light cone and surface plasmon states lying on surface plasmon dispersion curves;

FIG. 3 shows a top view of a portion of the surface plasmon resonance sensor shown in FIG. 1;

FIG. 4 shows a cross-section of a portion of the surface plasmon resonance sensor shown in FIG. 1;

FIG. 5 shows a portion of another surface plasmon resonance sensor in accordance with the invention;

FIG. 6 shows a portion of another surface plasmon resonance sensor in accordance with the invention;

FIG. 7 shows another surface plasmon resonance sensor in accordance with the invention; and

FIG. 8 shows a top view of a portion of another surface plasmon resonance sensor in accordance with the invention.

### DETAILED DESCRIPTION OF THE EMBODIMENTS

Reference will now be made in detail to embodiments in accordance with the invention, examples of which are illustrated in the accompanying drawings, wherein like reference numerals refer to the like elements throughout. The embodiments in accordance with the invention are described below.

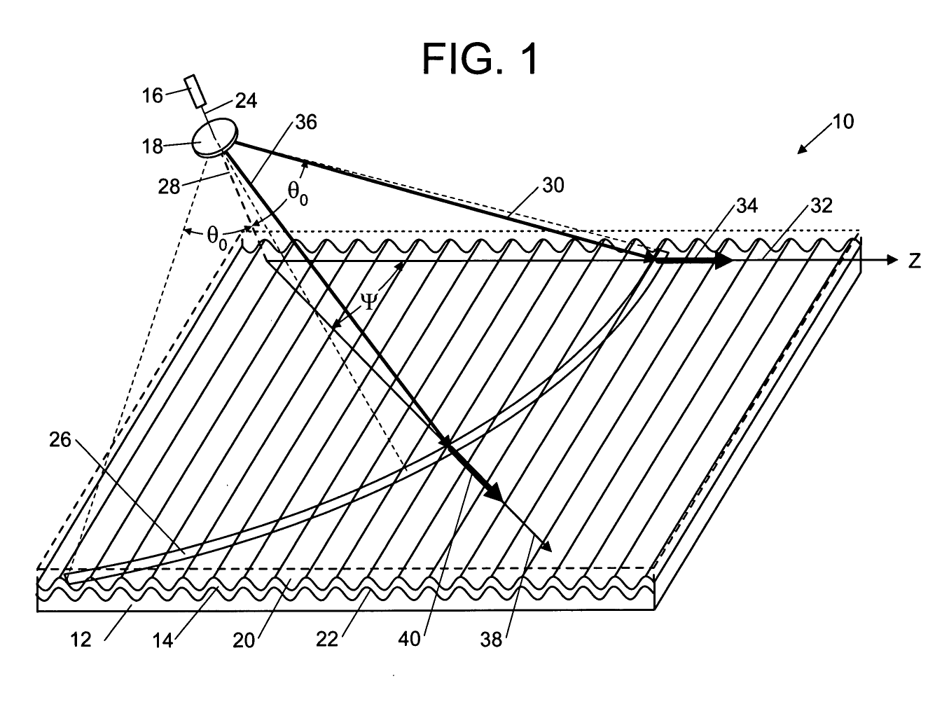

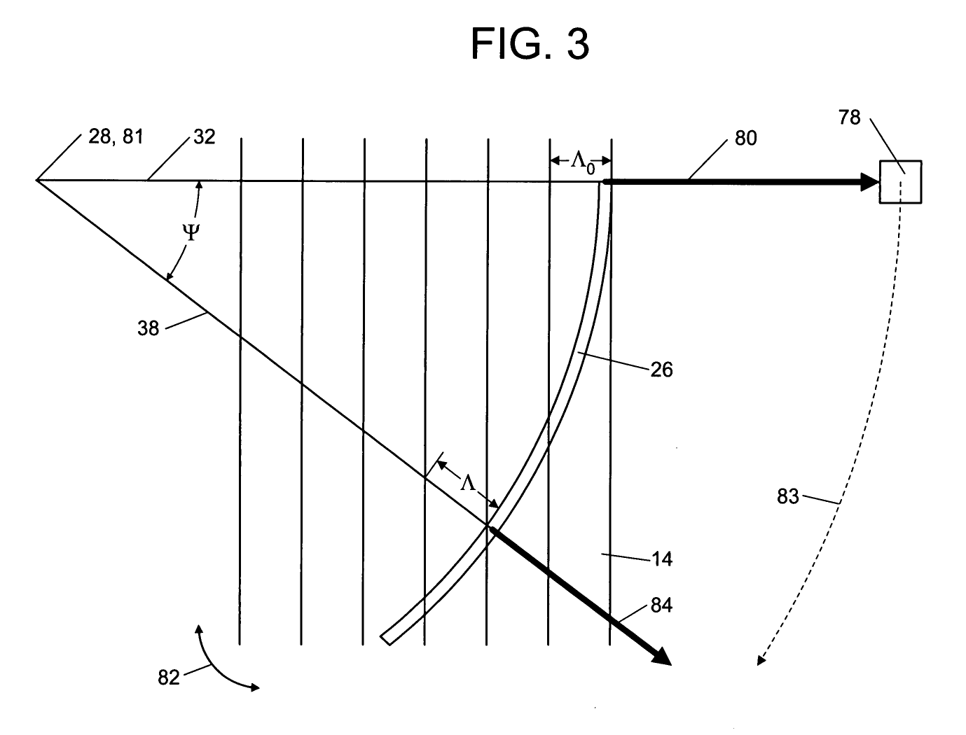

FIG. 1 shows a surface plasmon resonance sensor 10 in accordance with the invention that includes a substrate 12 having a flat bottom surface and a corrugated top surface, a conducting grating 14 having linear grooves formed on the corrugated top surface of the substrate 12, a light source 16, and a beam-shaping optical element 18. The light source 16 and the beam-shaping optical element 18 form a light beam source. A sample 20 to be analyzed is placed on the conducting grating 14, forming a conducting grating/sample interface 22 between the conducting grating 14 and the sample 20. The surface plasmon resonance sensor 10 also includes a detector that detects a reflected light beam produced by the conducting grating 14. The detector is not shown in FIG. 1, but is shown in FIG. 3 and is described below.

Alternatively, the substrate 12, the conducting grating 14, and the sample 20 may be flipped over so that the conducting grating 14 and the sample 20 are on the opposite side of the substrate 12 from the light source 16 and the beam-shaping optical element 18.

The light source 16 emits monochromatic light having a wavelength λ₀, and may be a laser or any other suitable monochromatic light source.

The beam-shaping optical element 18 transforms a light beam 24 having the wavelength λ₀ emitted from the light source 16 into an annular light beam 26 that is centered around a normal 28 to an imaginary plane contacting the conducting grating 14 and is incident on the conducting grating 14 at an incident angle θ₀ measured relative to the normal 28. Thus, all of the light in the annular light beam 26 is incident on the conducting grating 14 at the incident angle θ₀.

The beam-shaping optical element 18 may be an absorbent beam-shaping optical element that produces the annular light beam 26 by absorbing all of the light in the light beam 24 except for the light in the annular light beam 26, or a diffractive beam-shaping optical element that produces the annular light beam 26 from the light beam 24 by diffraction, or any other type of beam-shaping optical element capable of producing the annular light beam 26 from the light beam 24.

A Z axis 32 lies in the imaginary plane contacting the conducting grating 14, and intersects the normal 28 at a point that forms a vertex of an azimuthal angle ψ. The Z axis 32 is perpendicular to the linear grooves of the conducting grating 14, and corresponds to an azimuthal angle ψ=0°.

A light ray 30 in the annular light beam 26 is incident on the conducting grating 14 at a point where the annular light beam 26 intersects the Z-axis 32 having an azimuthal angle ψ=0°. A perpendicular projection of the light ray 30 onto the imaginary plane contacting the conducting grating 14 coincides with the Z axis 32. Thus, the light ray 30 also has an azimuthal angle ψ=0°. When a surface plasmon resonance condition for the light ray 30 is satisfied, the light ray 30 will generate surface plasmons 34 that will propagate along the conducting grating/sample interface 22 in the direction of the Z axis 32.

A light ray 36 in the annular light beam 26 is incident on the conducting grating 14 at a point where the annular light beam intersects a line 38 lying in the imaginary plane contacting the conducting grating 14. The line 38 is rotated from the Z axis 32 by an arbitrary azimuthal angle ψ. A perpendicular projection of the light ray 36 onto the imaginary plane contacting the conducting grating 14 coincides with the line 38. Thus, the light ray 36 also has an arbitrary azimuthal angle ψ. When a surface plasmon resonance condition for the light ray 36 is satisfied, the light ray 36 will generate surface plasmons 40 that will propagate along the conducting grating/sample interface 22 in the direction of the line 38.

As described in greater detail below, a surface plasmon resonance condition depends on the index of refraction of the sample 20, the index of refraction of the conducting grating 14, the incident angle θ₀ of the annular light beam 26, and the periodicity of the conducting grating 14. The surface plasmon resonance condition for the light ray 36 is different from the surface plasmon resonance condition for the light ray 30 because, as described in greater detail below, an effective periodicity of the conducting grating 14 as measured along the line 38 is different from an effective periodicity of the conducting grating 14 as measured along the Z-axis 32. Thus, the effective periodicity that is “seen” by the light ray 36 when the light ray 36 is incident on the conducting grating 14 is different from the effective periodicity that is “seen” by the light ray 30 when the light ray 30 is incident on the conducting grating 14. Accordingly, if the light ray 30 generates the surface plasmons 34, the light ray 36 cannot generate the surface plasmons 40. Conversely, if the light ray 36 generates the surface plasmons 40, the light ray 30 cannot generate the surface plasmons 34.

Thus, both the light ray 30 and the Z axis 32 (which coincides with the line formed by a perpendicular projection of the light ray 30 onto the imaginary plane contacting the conducting grating 14) correspond to a first surface plasmon resonance condition, and both the light ray 36 and the line 38 (which coincides with the line formed by a perpendicular projection of the light ray 36 onto the imaginary plane contacting the conducting grating 14) correspond to a second surface plasmon resonance condition that is different from the first surface plasmon resonance condition. Accordingly, since the light ray 30 and the Z-axis 32 corresponding to the first surface plasmon resonance condition have an azimuthal angle ψ=0°, and the light ray 36 and the line 38 corresponding to the second surface plasmon resonance condition have an arbitrary azimuthal angle ψ, a surface plasmon resonance condition for an arbitrary light ray in the annular light beam 26 can be considered to be a function of the azimuthal angle ψ.

Thus, in theory, under a fixed set of conditions, surface plasmons will only be generated by a single light ray having a single azimuthal angle ψ in the annular light beam 26 corresponding to a single surface plasmon resonance condition. That is, surface plasmon resonance will occur only at the single azimuthal angle ψ. However, in practice, surface plasmons will be generated by a plurality of light rays in a narrow section of the annular light beam 26 including the single light ray. If the fixed set of conditions changes, the surface plasmon resonance condition will change to a new surface plasmon resonance condition occurring at a new azimuthal angle ψ. One example of a change in the fixed set of conditions that can cause this to occur is a change in the index of refraction of the sample 20.

The conducting grating 14 produces a reflected light beam by reflecting all of the light rays in the annular light beam 26 with a very high reflectivity (typically exceeding 90%) except for the light ray having the azimuthal angle ψ at which surface plasmon resonance occurs. The conducting grating 14 reflects the light ray having the azimuthal angle ψ at which surface plasmon resonance occurs with a very low reflectivity (typically 5% or less) because most of the photons in the light ray having the azimuthal angle ψ at which surface plasmon resonance occurs are converted to surface plasmons that propagate along the conducting grating/sample interface 22, leaving very few photons to be reflected by the conducting grating 14. Accordingly, there is a reflectivity dip in the reflected light beam produced by the conducting grating 14 at the azimuthal angle ψ at which surface plasmon resonance occurs.

Accordingly, the azimuthal angle ψ at which surface plasmon resonance occurs can be detected by detecting the reflectivity dip in the reflected light beam produced by the conducting grating 14 with the detector referred to above, which, as indicated above, is not shown in FIG. 1 but is shown in FIG. 3. As described in greater detail below, the index of refraction of the sample 20 can be calculated from the detected azimuthal angle ψ. If the index of refraction of the sample 20 changes, the azimuthal angle ψ at which surface plasmon resonance occurs will also change, causing a new reflectivity dip to appear at a new azimuthal angle ψ in the reflected light beam. The new azimuthal angle ψ at which surface plasmon resonance occurs can be detected by detecting the new reflectivity dip in the reflected light beam, and the new index of refraction can be calculated from the detected new azimuthal angle ψ.

The substrate 12 may be made of glass or any other suitable material. The corrugated top surface of the substrate 12 may be formed using standard holographic and wet or dry etching techniques, and the conducting grating 14 may be formed by depositing a thin layer of a conducting material on the corrugated top surface of the substrate 12. Such a conducting grating 14 will have a sinusoidal profile, which is typically the most efficient profile for generating surface plasmons. The conducting grating 14 may have a thickness of about 50 nm and a periodicity Λ₀ of about 1 μm, although any suitable thickness and periodicity may be used.

The conducting material used to form the conducting grating 14 should be a conducting material that generates surface plasmons in the visible or infrared light ranges at a resonance angle that is convenient to detect. The conducting material must be pure because oxides, sulfides, and other compounds formed by atmospheric exposure or reaction with a sample interfere with the generation of surface plasmons. One example of a suitable conducting material is a metal. Suitable candidates for a metal to use to form the conducting grating 14 with respect to their optical properties include Au, Ag, Cu, Al, Na, and In. However, In is too expensive, Na is too reactive, Cu and Al produce a reflectivity dip which is too broad, and Ag is too susceptible to oxidation, although Ag has the lowest absorption losses for surface plasmons. That leaves Au as the most practical choice, even though it has higher surface losses for surface plasmons than does Ag.

A surface plasmon can be thought of as a very highly attenuated guided wave that is constrained to follow the conducting grating/sample interface 22, and is a combined oscillation of the electromagnetic field and the surface charges of the conducting grating 14. A surface plasmon is not a light radiative state or a plane wave because its electric field profile decays exponentially away from the conducting grating/sample interface 22. The electric field of a surface plasmon is called an evanescent wave.

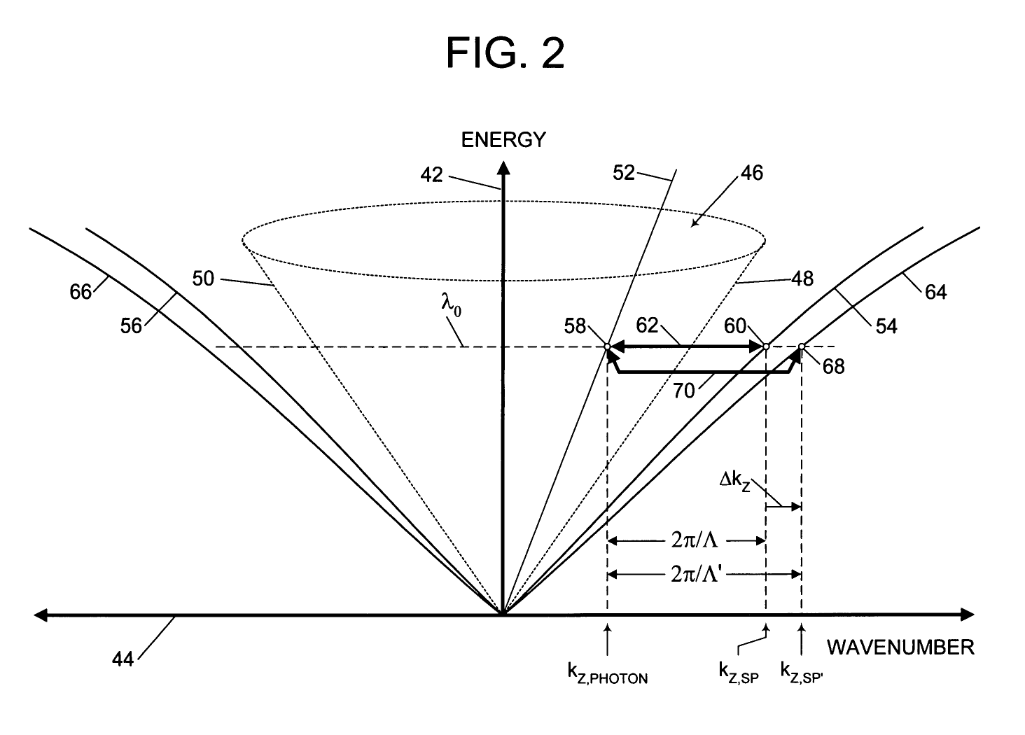

FIG. 2 shows a graph of energy plotted on a vertical energy axis 42 versus wavenumber k_{z} plotted on a horizontal wavenumber axis 44. The wavenumber k_{z} is a component of a wavenumber k parallel to the conducting grating/sample interface 22 along the Z axis 32.

The wavenumber k is defined by the following equation:

$$k = \frac{2 π}{λ} \qquad Equation 1$$

where λ is a wavelength.

The wavenumber k_{Z} is defined by the following equation:

$${k}_{z} = \frac{2 π}{λ} \cdot sin θ \qquad Equation 2$$

where λ is a wavelength and θ is an incident angle measured from a normal to an imaginary plane contacting the conducting grating 14.

In the surface plasmon resonance sensor 10 shown in FIG. 1, a photon incident on the conducting grating 14 travels through the sample 20 before it reaches the conducting grating/sample interface 22. The wavenumber k_{Z,PHOTON} of such a photon is defined by the following equation:

$${k}_{Z , PHOTON} = \frac{2 π}{λ} \cdot {n}_{d} \cdot sin θ \qquad Equation 3$$

where λ is the wavelength of the photon in a vacuum, n_{d} is the index of refraction of the sample 20, and θ is the incident angle of the photon measured from a normal to the imaginary plane contacting the conducting grating 14.

However, in the alternate configuration described above in which the substrate 12, the conducting grating 14, and the sample 20 in FIG. 1 are flipped over so that the conducting grating 14 and the sample 20 are on the opposite side of the substrate 12 from the light source 16 and the beam-shaping optical element 18, a photon incident on the conducting grating 14 travels through the substrate 12 before it reaches the conducting grating/sample interface 22. In this case, the index of refraction n_{d} in Equation 3 is the index of refraction of the substrate 12.

The relationship between energy E and wavelength λ is given by the following equation:

$$E = \frac{c \cdot h}{λ} \qquad Equation 4$$

where c is the speed of light and h is Planck's constant. As can be seen from Equation 4, energy E is inversely proportional to wavelength λ. Thus, as energy increases along the energy axis 42 in FIG. 2, wavelength decreases.

The relationship between momentum p and wavenumber k is given by the following equation:

p= [symbol] k Equation 5

where h (“h bar”) is the reduced Planck's constant (Planck's constant divided by 2π). As can be seen from Equation 5, momentum p is directly proportional to wavenumber k. Thus, as wavenumber increases along the wavenumber axis 44 in FIG. 2, momentum also increases.

Each point in the graph in FIG. 2 represents a photonic state where the properties of that state are its energy (or wavelength) and its wavenumber (or momentum).

A light radiative state or a plane wave state of light propagating in free space must always lie within a light cone 46 shown in FIG. 2. The light cone 46 represents all possible light radiative states or plane wave states. The right half of the light cone 46 on the right side of the energy axis 42 represents all possible light radiative states or plane wave states of photons that propagate in a forward direction, and the left half of the light cone 46 on the left side of the energy axis 42 represents light radiative states or plane wave states of photons that propagate in a backward direction. The energy axis 42 extending through the center of the light cone 46 represents light radiative states or plane wave states of photons that propagate normal to the imaginary plane contacting the conducting grating 14. A diagonal line 48 represents light radiative states or plane wave states of photons that propagate parallel to the imaginary plane contacting the conducting grating 14 in the forward direction, and a diagonal line 50 represents light radiative states or plane wave states of photons that propagate parallel to the imaginary plane contacting the conducting grating 14 in the backward direction. A diagonal line 52 represents light radiative states or plane wave states of photons that propagate at the incident angle θ₀ measured relative to the normal 28 to the imaginary plane contacting the conducting grating 14 as shown in FIG. 1 in the forward direction.

All possible surface plasmon states of surface plasmons that propagate forward along the conducting grating/sample interface 22 are represented by a surface plasmon dispersion curve 54 to the right of the energy axis 42, and all possible surface plasmon states of surface plasmons that propagate backward along the conducting grating/sample interface 22 are represented by a surface plasmon dispersion curve 56 to the left of the energy axis 42.

In FIG. 2, k_{Z,SP} is a wavenumber of a surface plasmon. The relationship between k_{Z,SP} and a frequency f of the surface plasmon is a dispersion relation for the surface plasmons, and is given by the following equation:

$${k}_{Z , SP} = \frac{2 π f}{c} \sqrt{\frac{{ɛ}_{m} {ɛ}_{d}}{{ɛ}_{m} + {ɛ}_{d}}} \qquad Equation 6$$

where c is the speed of light, εₘ is the permittivity of the conducting grating 14, and ε_{d} is the permittivity of the sample 20. However, for any material, E is a function of frequency, so Equation 6 is more complicated than it appears at first glance. Surface plasmon dispersion curves like surface plasmon dispersion curves 54 and 56 in FIG. 2 can be obtained by plotting frequency f as a function of k_{Z,SP} in accordance with Equation 6. Surface plasmon dispersion curves 54 and 56 in FIG. 2 are merely representational in nature and are provided merely to illustrate the general appearance of surface plasmon dispersion curves. However, surface plasmon dispersion curves will always lie outside the light cone 46.

The relationship between frequency f and wavelength λ is given by the following equation:

$$f = \frac{c}{λ} \qquad Equation 7$$

where c is the speed of light.

Substituting this relationship for f in Equation 6 results in the following relationship between the wavenumber k_{Z,SP} of the surface plasmon and a wavelength λ of the surface plasmon:

$${k}_{Z , SP} = \frac{2 π}{λ} \sqrt{\frac{{ɛ}_{m} {ɛ}_{d}}{{ɛ}_{m} + {ɛ}_{d}}} \qquad Equation 8$$

In order for a light radiative state to couple with a surface plasmon state, both energy and momentum must be conserved.

In order for energy to be conserved, a light radiative state 58, for example, of a photon having the wavelength λ₀ that is incident on the conducting grating 14 at the incident angle θ₀ as shown in FIG. 1 must couple with a surface plasmon state 60 having the same wavelength λ₀.

However, the wavenumber k_{Z,SP} (and thus the momentum p) of any surface plasmon state on the surface plasmon dispersion curve 54 on the right side of the energy axis 42 in FIG. 2 will always be greater than the wavenumber k_{Z,PHOTON} (and thus the momentum p) of any light radiative state at the same energy E (or wavelength λ) because the surface plasmon dispersion curve 54 lies outside the light cone 46. The same situation applies on the left side of the energy axis 42. Thus, any surface plasmon state is a nonradiative state and under normal circumstances cannot be coupled with a light radiative state because momentum would not be conserved. Accordingly, under normal circumstances, the light radiative state 58 cannot couple with the surface plasmon state 60.

However, this inability of the light radiative state 58 to couple with the surface plasmon state 60 is overcome by the presence of the conducting grating 14. In the presence of a grating, the wavenumber of any photonic state will change by the following amount:

$$\pm \frac{2 π}{Λ} \cdot m \qquad Equation 9$$

where Λ is the periodicity of the grating, and m is a diffraction order equal to an integer 1, 2, 3 . . . , which will be assumed to be equal to 1 in this discussion.

Thus, the presence of the conducting grating 14 causes the wavenumber k_{Z,PHOTON} of the photon having the wavelength λ₀ in the light radiative state 58 to increase by 2π/Λ and become equal to the wavenumber k_{Z,SP} of a surface plasmon having the same wavelength λ₀ in the surface plasmon state 60. Since the photon and the surface plasmon have the same wavelength, they also have the same energy, and since they now have the same wavenumber, they also now have the same momentum, and therefore the photon can couple with the surface plasmon since both energy and momentum are conserved. This coupling is represented by line 62 in FIG. 2. Thus, when a photon of wavelength λ₀ is incident on the conducting grating 14, it can be converted to a surface plasmon of wavelength λ₀ which propagates along the conducting grating/sample interface 22. The relationship between k_{Z,SP} and k_{Z,PHOTON} in this situation is given by the following equation:

$${k}_{Z , SP} = {k}_{Z , PHOTON} + \frac{2 π}{Λ} \qquad Equation 10$$

Substituting the expressions for k_{Z,SP} and k_{Z,PHOTON} from Equations 3 and 8 above into Equation 10 results in the following equation:

$$\frac{2 π}{{λ}_{0}} \sqrt{\frac{{ɛ}_{m} {ɛ}_{d}}{{ɛ}_{m} + {ɛ}_{d}}} = \frac{2 π}{{λ}_{0}} \cdot {n}_{d} \cdot sin {θ}_{0} + \frac{2 π}{Λ} \qquad Equation 11$$

where λ₀ is the wavelength λ₀ shown in FIG. 2 and θ₀ is the incident angle θ₀ shown in FIG. 1.

Equation 11 can be solved to find the periodicity Λ of the conducting grating 14 required to couple a photon having the wavelength λ₀ and the incident angle θ₀ to a surface plasmon having the same wavelength λ₀ propagating along the conducting grating/sample interface 22. Thus, Equation 11 defines the condition at which surface plasmon resonance occurs.

The index of refraction n of a material is defined by the following equation:

n=\sqrt{εᵣμᵣ} Equation 12

where εᵣ is the material's relative permittivity and μᵣ is the material's relative permeability.

For a non-magnetic material, μᵣ is very close to 1, and accordingly n is defined approximately by the following equation:

n≈\sqrt{εᵣ} Equation 13

A change in the sample 20 causes a change in the permittivity ε_{d} of the sample 20, and thus also causes a change in the index of refraction n_{d} of the sample 20 in accordance with Equation 13.

Equation 13 can be rewritten as follows:

εᵣ≈n² Equation 14

Accordingly, Equation 6 above can be rewritten as follows based on Equation 14:

$${k}_{Z , SP} = \frac{2 π f}{c} \sqrt{\frac{{n}_{m}^{2} {n}_{d}^{2}}{{n}_{m}^{2} + {n}_{d}^{2}}} \qquad Equation 15$$

Also, Equation 11 above can be rewritten as follows based on Equation 14:

$$\frac{2 π}{{λ}_{0}} \sqrt{\frac{{n}_{m}^{2} {n}_{d}^{2}}{{n}_{m}^{2} + {n}_{d}^{2}}} = \frac{2 π}{{λ}_{0}} \cdot {n}_{d} \cdot sin {θ}_{0} + \frac{2 π}{Λ} \qquad Equation 16$$

As can be seen from Equation 15 above, the surface plasmon dispersion curves 54 and 56 in FIG. 2 depend on the index of refraction n_{d} of the sample 20. If the index of refraction n_{d} of the sample 20 increases, the surface plasmon dispersion curves 54 and 56 rotate away from the light cone 46 and become new surface plasmon dispersion curves 64 and 66. Conversely, if the permittivity n_{d} of the sample 20 decreases, the surface plasmon dispersion curves 54 and 56 rotate toward the light cone 46 and become new surface plasmon dispersion curves which are not shown in FIG. 2 for the sake of simplicity.

Thus, the light radiative state 58 which previously coupled with the surface plasmon state 60 having the wavenumber k_{Z,SP} on the surface plasmon dispersion curve 54 must now couple with a surface plasmon state 68 having a wavenumber k_{Z,SP′} on the new surface plasmon dispersion curve 64 that is shifted by Δk_{Z} from the surface plasmon state 60. This requires the conducting grating 14 to have a different periodicity Λ′ to increase the wavenumber k_{Z,PHOTON} of the photon having the wavelength λ₀ in the light radiative state 58 by 2π/Λ′ to become equal to the wavenumber k_{Z,SP′} of a surface plasmon having the same wavelength λ₀ in the surface plasmon state 68, thereby allowing the photon to couple with the surface plasmon as indicated by the line 70 in FIG. 2.

As can be seen from Equation 16 above, if the index of refraction n_{d} of the sample 20 changes, one or more of the index of refraction nₘ of the conducting grating 14, the periodicity Λ of the conducting grating 14, the wavelength λ₀, and the incident angle θ₀ must change to restore the surface plasmon resonance condition.

It is not practical to change the index of refraction nₘ of the conducting grating 14 because this would typically require forming a new conducting grating 14 of a different material.

Also, it is not practical to physically change the periodicity Λ of the conducting grating 14 because this would typically require forming a new conducting grating 14 having a different periodicity Λ′.

One typical practice that has been employed in known surface plasmon resonance sensors would, if applied to the surface plasmon resonance sensor 10 in accordance with the invention shown in FIG. 1, include keeping the incident angle θ₀ fixed while changing the wavelength λ₀ until a new reflectivity dip is detected in a reflected light beam produced by the conducting grating 14, indicating that the surface plasmon resonance condition has been restored. However, changing the wavelength λ₀ typically requires a tunable laser, which is costly and may not have a large enough tuning range to detect a change in the index of refraction of the sample over a desired range.

Another typical practice that has been employed in known surface plasmon resonance sensors would, if applied to the surface plasmon resonance sensor 10 in accordance with the invention shown in FIG. 1 including keeping the wavelength λ₀ fixed while changing the incident angle θ₀ until a new reflectivity dip is detected in a reflected light beam produced by the conducting grating 14, indicating that the surface plasmon resonance condition has been restored. However, changing the incident angle θ₀ requires a very precise mechanism for making and measuring minute changes in the incident angle θ₀. For example, if the sample 20 is air and a contaminant increases the index of refraction n_{d} of the air from 1.0 to 1.000001, the incident angle θ₀ at which the reflectivity dip occurs will change by 0.00012° at a fixed wavelength of 1 μm. A mechanism capable of making and measuring such a small change in the incident angle θ₀ is costly and is susceptible to perturbations from environmental factors such as temperature and vibration.

Accordingly, in the surface plasmon resonance sensor 10 in accordance with the invention shown in FIG. 1, the incident angle θ₀ and the wavelength λ₀ are kept fixed while the periodicity Λ of the conducting grating 14 is effectively varied by emitting the annular light beam 26 containing light rays having different azimuthal angles ψ onto the conducting grating 14 and varying an azimuthal angle ψ at which a reflected light ray produced by the conducting grating 14 is detected until a new reflectivity dip is detected, indicating that the surface plasmon resonance condition has been restored.

FIG. 3 shows a top view of a portion of the conducting grating 14 onto which the annular light beam 26 is emitted. As discussed above in connection with FIG. 1, the annular light beam 26 is centered around the normal 28 to the imaginary plane contacting the conducting grating 14. The imaginary plane coincides with the plane of the paper in FIG. 3. The normal 28 is perpendicular to the plane of the paper in FIG. 3, and passes through the vertex of the azimuthal angle ψ. The Z axis 32 is perpendicular to the linear grooves of the conducting grating 14 and corresponds to an azimuthal angle ψ=0°.

The conducting grating 14 has an actual periodicity Λ₀ as measured in the direction of the Z axis 32. Thus, the periodicity that is “seen” by a light ray having an azimuthal angle ψ=0° in the annular light beam 26 is the actual periodicity Λ₀.

However, as measured in the direction of the line 38 that is rotated from the Z axis 32 by an arbitrary azimuthal angle ψ, the conducting grating 14 has an effective periodicity Λ defined by the following equation:

$$Λ = \frac{{Λ}_{0}}{cos Ψ} \qquad Equation 17$$

Thus, the periodicity that is “seen” by a light ray having the arbitrary azimuthal angle ψ in the annular light beam 26 is the effective periodicity Λ. This holds true for any light ray in the annular light beam 26.

Accordingly, Equation 16 above can be rewritten as follows based on Equation 17:

$$\frac{2 π}{{λ}_{0}} \sqrt{\frac{{n}_{m}^{2} {n}_{d}^{2}}{{n}_{m}^{2} + {n}_{d}^{2}}} = \frac{2 π}{{λ}_{0}} \cdot {n}_{d} \cdot sin {θ}_{0} + \frac{2 π}{{Λ}_{0}} \cdot cos Ψ \qquad Equation 18$$

According to Equation 18, for a given set of n_{d}, nₘ, λ₀, θ₀, and Λ₀, surface plasmons will only be generated by a single light ray having a single azimuthal angle ψ in the annular light beam 26 corresponding to a single surface plasmon resonance condition. That is, surface plasmon resonance will only occur at the single azimuthal angle ψ. However, in practice, surface plasmons will be generated by a plurality of light rays in a narrow section of the annular light beam 26 including the single light ray.

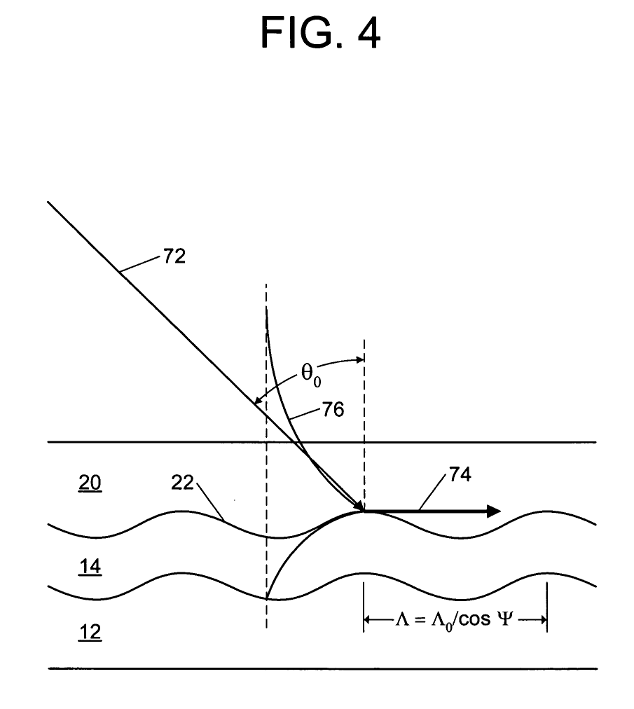

FIG. 4 shows a cross-section of a portion of the surface plasmon resonance sensor 10 shown in FIG. 1 taken along a line at an arbitrary azimuthal angle ψ relative to the Z axis 32. A photon 72 incident on the conducting grating 14 through the sample 20 at the incident angle θ₀ “sees” an effective periodicity Λ=Λ₀/cos ψ and is converted to a surface plasmon 74 that propagates along the conducting layer/sample interface 22. The surface plasmon has an evanescent wave that extends away from the conducting grating/sample interface 22 into the conducting grating 14 and the sample 20. The evanescent wave has an electric field profile 76 that decays exponentially away from the conducting grating/sample interface 22, with the portion extending into the conducting grating 14 decaying faster than the portion extending into the sample 20 because the absorption losses in the conducting grating 14 are higher than the absorption losses in the sample 20. The vertical dashed line toward which the electric field profile 76 decays represents an electric field of zero.

FIG. 3 shows the conducting grating 14 reflecting the annular light beam 26 to produce a reflected light beam containing reflected light rays corresponding to different surface plasmon resonance conditions. A detector 78 is positioned to detect a reflected light ray 80 having an azimuthal angle ψ=0° corresponding to one surface plasmon resonance condition produced by the conducting grating 14 reflecting a light ray having an azimuthal angle ψ=0° in the annular light beam 26. A perpendicular projection of the reflected light ray 80 onto the imaginary plane contacting the conducting grating 14 coincides with the Z axis 32 as shown in FIG. 3. Rotating the conducting grating 14 relative to the detector 78 as conceptually indicated by the arrows 82 enables the detector 78 to detect a reflected light ray 84 having an arbitrary azimuthal angle ψ corresponding to another surface plasmon resonance condition produced by the conducting grating 14 reflecting a light ray having an arbitrary azimuthal angle ψ in the annular light beam 26. A perpendicular projection of the reflected light ray 84 onto the imaginary plane contacting the conducting grating 14 coincides with the line 38 as shown in FIG. 3. However, in practice, the conducting grating 14 should be rotated about the vertex of the azimuthal angle ψ, which is the point where the normal 28 intersects the plane of the paper in FIG. 3. The light source 16 and the beam-shaping optical element 18 may remain fixed while the conducting grating 14 is rotated if the annular light beam 26 is perfectly circular and perfectly centered around the normal 28. However, if this is not the case, the light source 16 and the beam-shaping optical element 18 may be rotated together with the conducting grating 14 to minimize the effects of variations in the circularity and centering of the annular light beam 26.

Alternatively, the light source 16, the beam-shaping optical element 18, and the conducting grating 14 can remain fixed while the detector 78 is moved relative to the conducting grating 14 along a curved path 83 to detect the reflected light ray 84. A center of radius 81 of the curved path 83 coincides with the vertex of the azimuthal angle ψ, which is the point where the normal 28 intersects the plane of the paper in FIG. 3.

Thus, to analyze the sample 20, the conducting grating 14 is rotated (or the detector 78 is moved) until the detector 78 detects the reflectivity dip, indicating that a surface plasmon resonance condition has been achieved, and the corresponding azimuthal angle ψ is recorded. The index of refraction n_{d} of the sample 20 can then be calculated from Equation 18 above because all of the other variables (nₘ, λ₀, θ₀, Λ₀, and ψ) are known.

If there is a change in the sample 20, the index of refraction n_{d} of the sample 20 will change, which will change the conditions to achieve surface plasmon resonance so that the detector 78 will no longer detect the reflectivity dip. The conducting grating 14 is then rotated until a new reflectivity dip is detected, indicating that the surface plasmon resonance condition has been restored, and the corresponding new azimuthal angle ψ is recorded. The new index of refraction n_{d} of the sample 20 can then be calculated from Equation 18.

As described above, the typical method that has been employed in known surface plasmon resonance sensors of keeping the wavelength λ₀ fixed and changing the incident angle θ₀ until a new reflectivity dip is detected is problematic because it requires a very precise mechanism for making and measuring minute changes in the incident angle θ₀, and such a mechanism is costly and is susceptible to perturbations from environmental factors such as temperature and vibration.

Although the surface plasmon resonance sensor 10 in accordance with the invention shown in FIG. 1 also requires a mechanism for making and measuring minute changes in the azimuthal angle ψ, this mechanism needs to be far less precise than the mechanism required in the typical method referred to above.

For example, if the sample 20 is air and a contaminant increases the index of refraction n_{d} of the air from 1.0 to 1.000001, the surface plasmon dispersion curve will shift by Δk_{Z}=0.0000065 at a fixed wavelength λ₀=1 μm, corresponding to Δk_{Z} in FIG. 2. This will change the incident angle θ₀ by 0.00012° in the typical method referred to above, which requires a very precise mechanism to make and measure such a small change.

In contrast, if the actual periodicity of the conducting grating 14 in the surface plasmon resonance sensor 10 in accordance with the invention shown in FIG. 1 is Λ₀=1 μm, a light ray having an azimuthal angle ψ=0.082° in the annular light beam 26 will “see” an effective periodicity Λ=1 μm/cos 0.082°=1.000001 μm. This change in effective periodicity is sufficient to detect the shift in the surface plasmon dispersion curve of Δk_{Z}=0.0000065 at the fixed wavelength λ₀=1 μm in the above example in which the index of refraction n_{d} of air changes from 1.0 to 1.000001. However, the change of 0.082° in the azimuthal angle ψ that must be detected is 683 times larger than the change of 0.00012° in the incident angle θ₀ that must be detected in the typical method referred to above. Accordingly, the mechanism for making and measuring changes in the azimuthal angle ψ in the surface plasmon resonance sensor 10 in accordance with the invention shown in FIG. 1 may be far less precise than the mechanism for making and measuring changes in the incident angle θ₀ in the typical method referred to above. Alternatively, a mechanism with a given precision will produce a measurement of far greater sensitivity in the surface plasmon resonance sensor 10 in accordance with the invention shown in FIG. 1 than it will in the typical method referred to above.

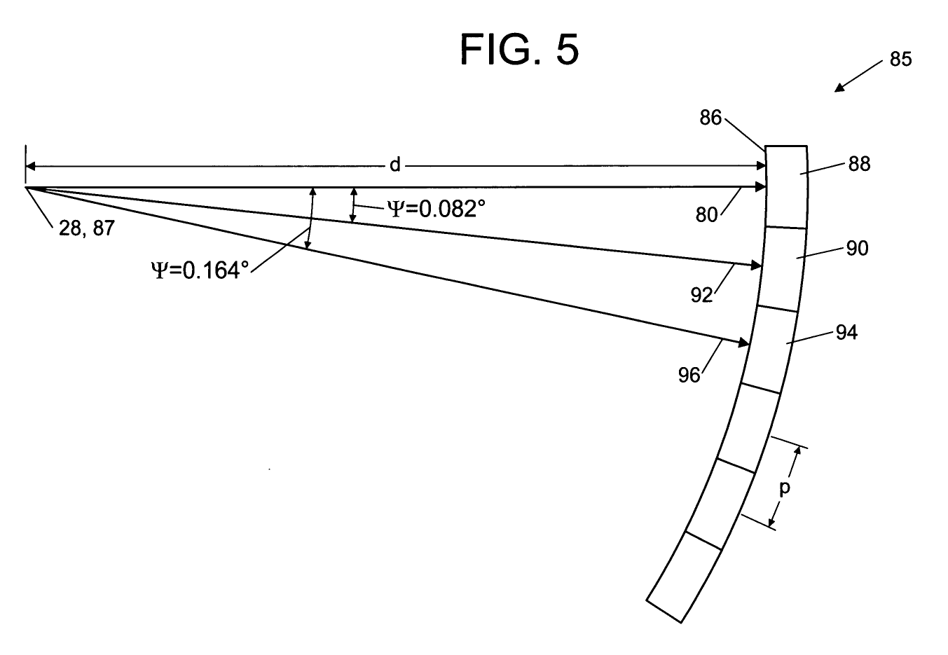

FIG. 5 shows a portion of another surface plasmon resonance sensor 85 in accordance with the invention which is a modification of the surface plasmon resonance sensor 10 shown in FIGS. 1 and 3 in which a curved line sensor 86 including a plurality of pixels replaces the detector 78 in FIG. 3. The curved line sensor 86 may be a CMOS curved line sensor, or a CCD curved line sensor, or any other suitable curved line sensor. The curved line sensor 86 is spaced apart from a vertex of the azimuthal angle ψ by a distance d that provides a desired angular resolution Δψ at the curved line sensor 86, and has a radius equal to the distance d. A center of radius 87 of the curved line sensor 86 coincides with the vertex of the azimuthal angle ψ, which is the point where the normal 28 intersects the plane of the paper in FIG. 5. The distance d is defined by the following equation:

$$d = \frac{p}{tan Δ Ψ} \qquad Equation 19$$

where p is a pitch of the pixels of the curved line sensor 86, and Δψ is the desired angular resolution at the curved line sensor 86.

For example, in the example discussed above, a change of 0.000001 (from 1.0 to 1.000001) in the index of refraction n_{d} of the sample 20 produces a change of 0.082° in the azimuthal angle ψ. Thus, an angular resolution of Δψ=0.082° at the curved line sensor 86 will enable a change of 0.000001 in the index of refraction n_{d} of the sample 20 to be detected. For a curved line sensor 86 in which the pixels have a typical pitch of 5.6 μm, d=5.6 μm/tan 0.082°=3.9 mm. However, a curved line sensor 86 having pixels with any suitable pitch can be used, and d can be calculated based on the pitch actually used.

As shown in FIG. 5, a first pixel 88 of the curved line sensor 86 receives the reflected light ray 80 having an azimuthal angle ψ=0° shown in FIG. 3. A second pixel 90 receives a reflected light ray 92 having an azimuthal angle ψ=0.082°. A third pixel 94 receives a reflected light ray 96 having an azimuthal angle ψ=0.164°, and so on, with each successive pixel detecting a reflected light ray having an incremental azimuthal angle Δψ=0.082° corresponding to an incremental change Δn_{d}=0.000001 in the index of refraction n_{d} of the sample 20. The incremental azimuthal angles Δψ shown in FIG. 5 are greatly magnified to more clearly show this aspect of the invention. Accordingly, only six pixels are shown in FIG. 5. In practice, the curved line sensor 86 will have many pixels, and any suitable number of pixels can be used.

Under any given set of conditions, one of the pixels of the curved line sensor 86 will detect the reflectivity dip indicating that the surface plasmon resonance condition has been achieved. Thus, the output signal of that pixel will be low, while the output signals of all of the other pixels in the curved line sensor 86 will be high. By reading out the output signals of the pixels of the curved line sensor 86, it is possible to determine which pixel has the low output signal, and based on that, it is possible to determine the azimuthal angle ψ where the reflectivity dip occurs.

For example, assume that when the output signals of the pixels of the curved line sensor 86 are read out, pixel number 62 has a low output signal, where the pixels are numbered sequentially beginning with 1 for the pixel 88 corresponding to an azimuthal angle ψ=0°. This means that the azimuthal angle ψ where the reflectivity dip occurs is ψ=(62−1)×0.082°=5.002°. The index of refraction n_{d} of the sample 20 can then be calculated from Equation 18 above.

Now assume there is a change in the sample 20, and when the output signals of the pixels of the curved line sensor 86 are read out, pixel number 73 has a low output signal. This means that the new azimuthal angle ψ where the new reflectivity dip occurs is ψ=(73−1)×0.082°=5.904°. The new index of refraction n_{d} of the sample 20 can then be calculated from Equation 18 above. Alternatively, the change in the index of refraction n_{d} of the sample 20 can be calculated as Δn_{d}=(73−62)×(0.000001)=0.000011, and this change Δn_{d} can be added to the index of refraction n_{d} calculated above for the original azimuthal angle ψ=5.002° to obtain the new index of refraction n_{d}.

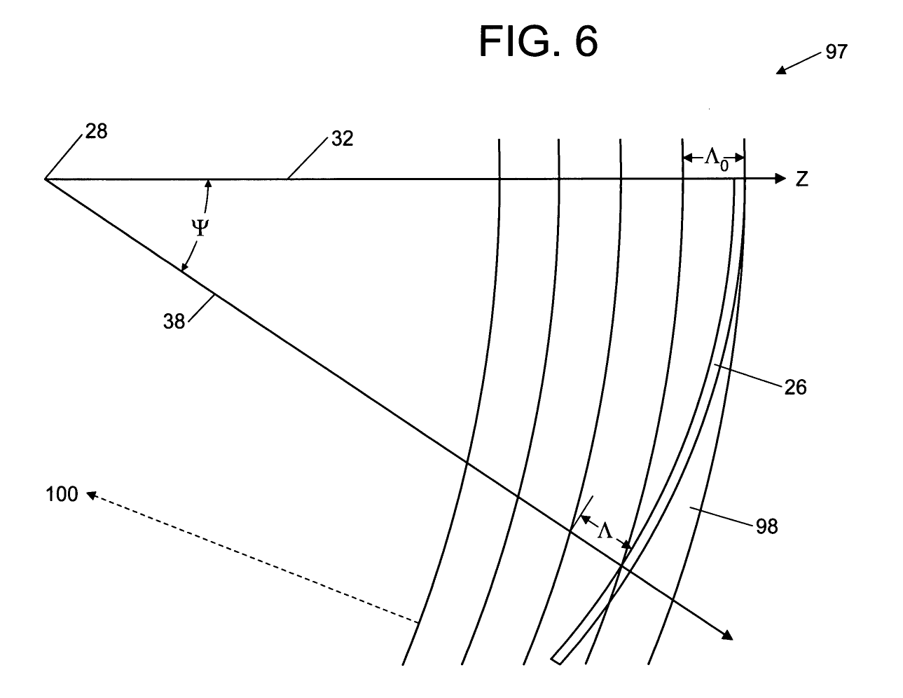

FIG. 6 shows a portion of another surface plasmon resonance sensor 97 in accordance with the invention which is a modification of the surface plasmon resonance sensor 10 shown in FIG. 1 in which a conducting grating 98 having circular grooves replaces the conducting grating 14 having linear grooves. The circular grooves can be formed using the same techniques used to form the linear grooves of the conducting grating 14 as described above in connection with FIG. 1. The circular grooves have a center of curvature 100 which is not located at the vertex of the azimuthal angle ψ, which is the point where a normal 28 to an imaginary plane contacting the conducting 98 intersects the plane of the paper in FIG. 6. The imaginary plane coincides with the plane of the paper in FIG. 6. That is, the normal 28 is perpendicular to the plane of the paper in FIG. 6 and passes through the vertex of the azimuthal angle ψ, but does not pass through the center of curvature 100 of the circular grooves of the conducting grating 98. This configuration causes the change in the effective periodicity Λ for a given change Δψ in the azimuthal angle ψ to be smaller than in the surface plasmon resonance sensor 10 shown in FIG. 1. This makes the surface plasmon resonance sensor 97 shown in FIG. 6 more sensitive than the surface plasmon resonance sensor 10 shown in FIG. 1.

The surface plasmon resonance sensor 97 shown in FIG. 6 may use either the detector shown in FIG. 3 or the curved line sensor shown in FIG. 5, and may be modified to have elliptical grooves or any other type of curved grooves in place of the circular grooves on the conducting grating 98.

The operation of the surface plasmon resonance sensor 97 shown in FIG. 6 in analyzing the sample 20 is substantially the same as the operation of the surface plasmon resonance sensor 10 shown in FIGS. 1 and 3 and the surface plasmon resonance sensor 85 shown in FIG. 5 as described above, and thus will not be described in detail here.

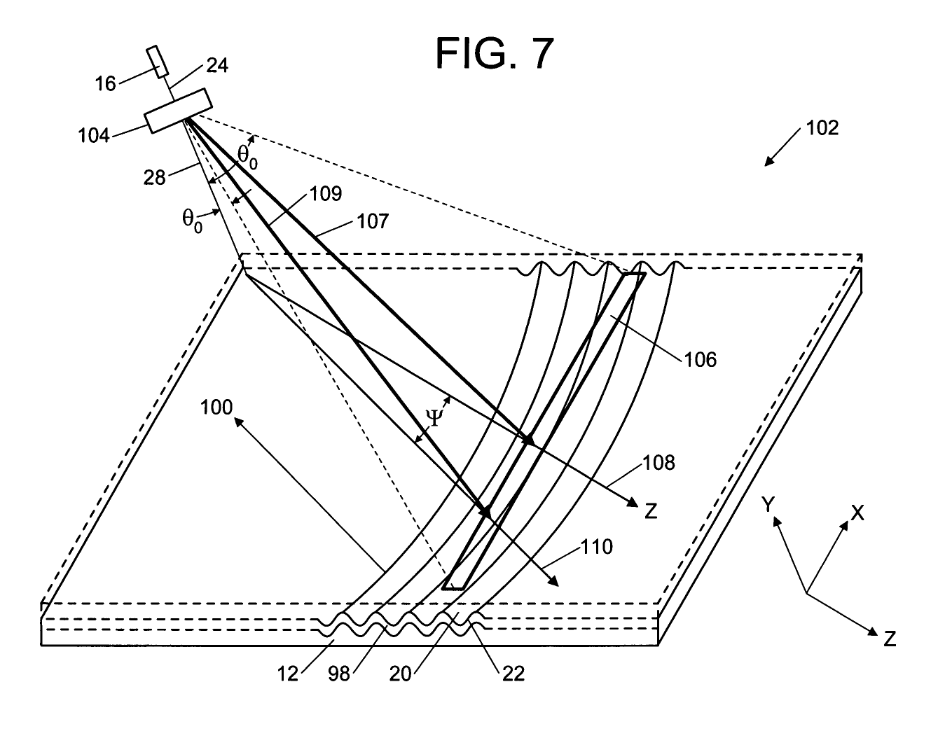

FIG. 7 shows another surface plasmon resonance sensor 102 in accordance with the invention that includes a substrate 12 having a flat bottom surface and a corrugated top surface, a conducting grating 98 having circular grooves formed on the corrugated top surface of the substrate 12, a light source 16, and a beam-shaping optical element 104. The light source 16 and the beam-shaping optical element 104 form a light beam source. A sample 20 to be analyzed is placed on the conducting grating 98, forming a conducting grating/sample interface 22 between the conducting grating 98 and the sample 20. The surface plasmon resonance sensor 102 also includes a detector that detects a reflected light beam produced by the conducting grating 98. The detector is not shown in FIG. 7, but may be the detector 78 shown in FIG. 3 or the curved line sensor 86 shown in FIG. 5.

Alternatively, the substrate 12, the conducting grating 98, and the sample 20 may be flipped over so that the conducting grating 98 and the sample 20 are on the opposite side of the substrate 12 from the light source 16 and the beam-shaping optical element 104.

The circular grooves of the conducting grating 98 can be formed using the same techniques used to form the linear grooves of the conducting grating 14 shown in FIG. 1 as described above in connection with FIG. 1.

The light source 16 emits monochromatic light having a wavelength λ₀, and may be a laser or any other suitable monochromatic light source.

The beam-shaping optical element 104 transforms a light beam 24 having the wavelength λ₀ emitted from the light source 16 into a linear light beam 106 that is incident on the conducting grating 98 at an incident angle θ₀ measured relative to a normal 28 to an imaginary plane contacting the conducting grating 98. Thus, all of the light in the linear light beam 106 is incident on the conducting grating 98 at the incident angle θ₀.

The beam-shaping optical element 104 substantially collimates the linear light beam 106 in a Y-direction indicated by a set of XYZ coordinate axes shown in FIG. 7, but does not substantially collimate the linear light beam 106 in an X-direction indicated by the set of XYZ coordinate axes, such that the linear light beam 106 contains light rays that diverge in the X direction, such as light rays 107 and 109. The beam-shaping optical element 104 may be a collimating element, such as a cylindrical lens oriented to substantially collimate the linear light beam 106 in the Y-direction, or any other type of beam-shaping optical element capable of producing the linear light beam 106.

A Z axis 108 lies in the imaginary plane contacting the conducting grating 98, and intersects the normal 28 at a point that forms a vertex of an azimuthal angle ψ. The Z axis 108 is perpendicular to both the linear light beam 106 and the circular grooves of the conducting grating 98, and corresponds to an azimuthal angle ψ=0°. The circular grooves of the conducting grating 98 have a center of curvature 100 which is not located at the vertex of the azimuthal angle ψ. That is, the normal 28 passes through the vertex of the azimuthal angle ψ, but does not pass through the center of curvature 100 of the circular grooves of the conducting grating 98.

The light ray 107 in the linear light beam 106 is incident on the conducting grating 98 at a point where the linear light beam 106 intersects the Z axis 108 having an azimuthal angle ψ=0°. A perpendicular projection of the light ray 107 onto the imaginary plane contacting the conducting grating 98 coincides with the Z axis 108. Thus, the light ray 107 also has an azimuthal angle ψ=0°.

The light ray 109 in the linear light beam 106 is incident on the conducting grating 98 at a point where the linear light beam 106 intersects a line 110 lying in the imaginary plane contacting the conducting grating 98. The line 110 is rotated from the Z axis 108 by an arbitrary azimuthal angle ψ. A perpendicular projection of the light ray 109 onto the imaginary plane contacting the conducting grating coincides with the line 110. Thus, the light ray 109 also has an arbitrary azimuthal angle ψ.

In the surface plasmon resonance sensor 10 shown in FIG. 1, a variation in an effective periodicity Λ of the conducting grating 14 with the azimuthal angle ψ is achieved by emitting the annular light beam 26 onto the conducting grating 14 having the linear grooves. In the surface plasmon resonance sensor 102 shown in FIG. 7, the same effect is achieved by emitting the linear light beam 106 onto the conducting grating 98 having the circular grooves. The variation in the effective periodicity Λ with the azimuthal angle ψ achieved in the surface plasmon resonance sensor 10 shown in FIG. 1 is given by Equation 17 above, that is, Λ=Λ₀/cos ψ. However, it is not possible to express the variation in the effective periodicity Λ with the azimuthal angle ψ achieved in the surface plasmon resonance sensor 102 shown in FIG. 7 with a simple equation similar to Equation 17 because the center of curvature 100 of the circular grooves of the conducting grating 98 is not located at the vertex of the azimuthal angle ψ.

As indicated above, the surface plasmon resonance sensor 102 shown in FIG. 7 may use either the detector 78 shown in FIG. 3 or the curved line sensor 86 shown in FIG. 5. Also, the surface plasmon resonance sensor 102 shown in FIG. 7 may be modified to have elliptical grooves or any other type of curved grooves in place of the circular grooves of the conducting grating 98.

The operation of the surface plasmon resonance sensor 102 shown in FIG. 7 in analyzing the sample 20 is substantially the same as the operation of the surface plasmon resonance sensor 10 shown in FIGS. 1 and 3 and the surface plasmon resonance sensor 85 shown in FIG. 5 as described above, and thus will not be described in detail here.

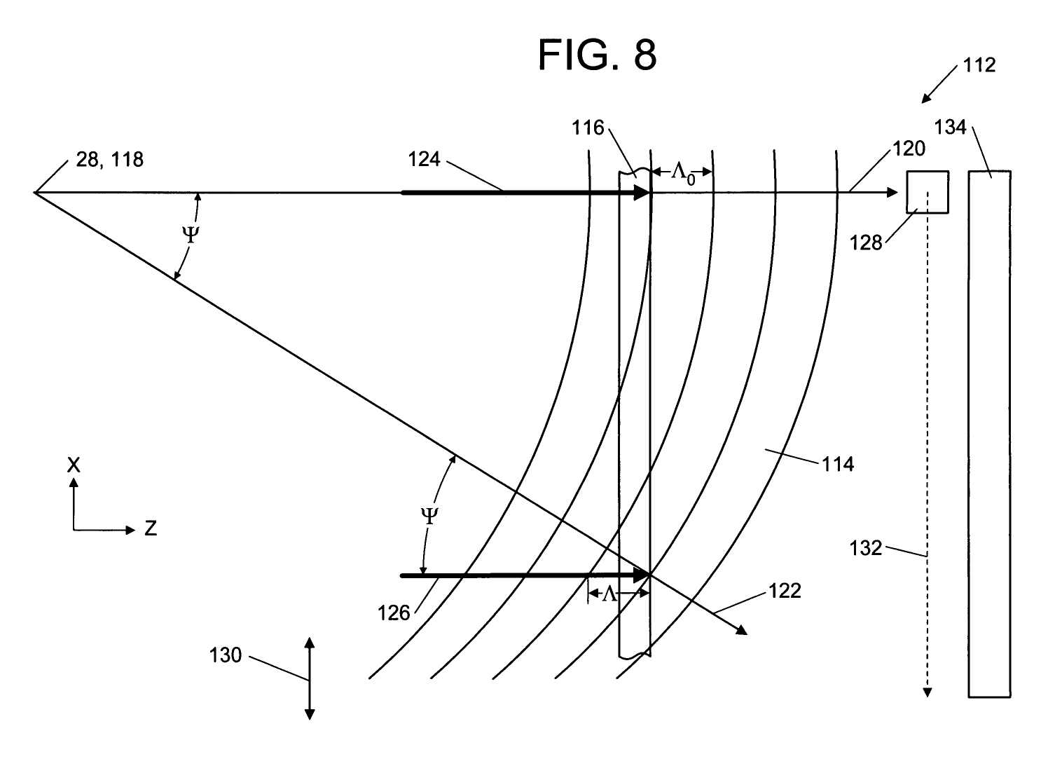

FIG. 8 shows a top view of a portion of another surface plasmon resonance sensor 112 in accordance with the invention that is a modification of the surface plasmon resonance sensor 102 shown in FIG. 7 and has the same general configuration as the surface plasmon resonance sensor 102 shown in FIG. 7 except as discussed below.

The surface plasmon resonance sensor 112 shown in FIG. 8 includes a conducting grating 114 having circular grooves that replaces the conducting grating 98 shown in FIG. 7.

A beam-shaping optical element (not shown in FIG. 8) replaces the beam-shaping optical element 104 shown in FIG. 7, and produces a linear light beam 116 that is incident on the conducting grating 114 at an incident angle θ₀ measured relative to a normal 28 to an imaginary plane contacting the conducting grating 114. The imaginary plane coincides with the plane of the paper in FIG. 8, such that the normal 28 is perpendicular to the plane of the paper in FIG. 8. Thus, all of the light in the linear light beam 116 is incident on the conducting grating 114 at the incident angle θ₀.

The unillustrated beam-shaping optical element substantially collimates the linear light beam 116 in a Y-direction which is perpendicular to the plane of the paper in FIG. 8, and also substantially collimates the linear light beam 116 in an X-direction indicated by a set of XZ coordinate axes shown in FIG. 8, such that the linear light beam 116 contains light rays that do not diverge in the X direction, such as light rays 124 and 126. The unillustrated beam-shaping optical element may be a collimating element, such as a pair of cylindrical lenses, one of which is oriented to substantially collimate the linear light beam 116 in the Y-direction and the other of which is oriented to substantially collimate the linear light beam 116 in the X-direction, or any other type of beam-shaping optical element capable of producing the linear light beam 116.

A Z axis 120 lies in the imaginary plane contacting the conducting grating 114, and intersects the normal 28 at a point that forms a vertex of an azimuthal angle ψ. The Z axis 120 is perpendicular to both the linear light beam 116 and the circular grooves of the conducting grating 114, and corresponds to an azimuthal angle ψ=0. The circular grooves of the conducting grating 114 have a center of curvature 118 which is located at the vertex of the azimuthal angle ψ. That is, the normal 28 passes through the vertex of the azimuthal angle ψ and the center of curvature 118 of the circular grooves of the conducting grating 114.

The light ray 124 in the linear light beam 116 is incident on the conducting grating 114 at a point where the linear light beam 116 intersects the Z axis 120 having an azimuthal angle ψ=0°. A perpendicular projection of the light ray 124 onto the imaginary plane contacting the conducting grating 114 coincides with the Z axis 120. Thus, the light ray 124 also has an azimuthal angle of ψ=0°.

The light ray 126 in the linear light beam 116 is incident on the conducting grating 114 at a point wherein the linear light beam 116 intersects a line 122 lying in the imaginary plane contacting the conducting grating 114. The line 122 is rotated from the Z axis 120 by an arbitrary azimuthal angle ψ. A perpendicular projection of the light ray 126 onto the imaginary plane contacting the conducting grating 114 forms an angle ψ with the line 122 that is equal to the arbitrary azimuthal angle ψ by which the line 122 is rotated from the Z axis 120. Thus, the light ray 126 is defined as having an arbitrary azimuthal angle ψ for the purpose of calculating an effective periodicity Λ of the conducting grating 114 as described below.

The conducting grating 114 has an actual periodicity Λ₀ as measured in the direction of the Z axis 120. Thus, the periodicity that is “seen” by the light ray 124 having an azimuthal angle ψ=0° is the actual periodicity Λ₀.

However, as measured in the direction of a line formed by a perpendicular projection of the light ray 126 defines as having an arbitrary azimuthal angle ψ onto the imaginary plane contacting the conducting grating 114, the conducting grating 114 has an effective periodicity Λ defined by Equation 17 above, that is, Λ=Λ₀/cos ψ. Thus, the periodicity that is “seen” by the light ray 126 having an arbitrary azimuthal angle ψ is the effective periodicity Λ. This holds true for any light ray in the linear light beam 116.

The surface plasmon resonance sensor 112 shown in FIG. 8 may include a detector 128 which is similar to the detector 78 shown in FIG. 3 to detect light rays corresponding to difference surface plasmon resonance conditions (that is, light rays defined as having different azimuthal angles ψ) in a reflected light beam produced by the conducting grating 114 reflecting the linear light beam 116 in order to detect a reflectivity dip in the reflected light beam indicating that a surface plasmon resonance condition has been achieved. However, since all of the light rays in the linear light beam 116 are parallel to the Z axis 120 when viewed in the direction perpendicular to the imaginary plane contacting the conducting grating 114 as shown in FIG. 8, all of the light rays in the reflected light beam will also be parallel to the Z axis 120 when viewed in this direction. Accordingly, the rest of surface plasmon resonance sensor 112 can be moved relative to the detector 128 in a direction parallel to the linear light beam 116 and perpendicular to the Z axis 120 as conceptually indicated by the arrows 130 in FIG. 8 in order to detect the reflectivity dip in the reflected light beam.

Alternatively, the rest of the surface plasmon resonance sensor 112 can remain fixed while the detector 128 is moved relative to the conducting grating 114 along a straight path 132 parallel to the linear light beam 116 and perpendicular to the Z axis 120 as shown in FIG. 8 to detect the reflectivity dip in the reflected light beam Each reflected light ray in the reflected light beam is defined as having an azimuthal angle ψ in the same manner that each light ray in the linear light beam 116 is defined as having an azimuthal angle ψ as described above in connection with the light ray 126.

Alternatively, the surface plasmon resonance sensor 112 shown in FIG. 8 can use a straight line sensor 134 (that is, a linear sensor) to detect the reflectivity dip in the reflected light beam using the same method that is used to detect a reflectivity dip with the curved line sensor 86 shown in FIG. 5 as described above in connection with FIG. 5.

The surface plasmon resonance sensor 112 shown in FIG. 8 may be modified so that the center of curvature 118 of the circular grooves of the conducting grating 114 is not located at the vertex of the azimuthal angle ψ, that is, so that the normal 28 passes through the vertex of the azimuthal angle ψ but does not pass through the center of curvature 118 of the circular grooves of the conducting grating 114. Also, the surface plasmon resonance sensor 112 shown in FIG. 8 may be modified to have elliptical grooves or any other type of curved grooves in place of the circular grooves of the conducting grating 114. However, if such a modification is made, the effective periodicity Λ of the conducting grating 114 will no longer be defined by Equation 17 above, that is, Λ=Λ₀/cos ψ. The effective periodicity Λ will still vary with the azimuthal angle ψ, but it is not possible to express this variation with a simple equation similar to Equation 17.

The operation of the surface plasmon resonance sensor 112 shown in FIG. 8 in analyzing the sample 20 is substantially the same as the operation of the surface plasmon resonance sensor 10 shown in FIGS. 1 and 3 and the surface plasmon resonance sensor 85 shown in FIG. 5 as described above, and thus will not be described in detail here.

In a surface plasmon resonance sensor in accordance with the invention, such as the surface plasmon resonance sensors described above, a light beam emitted onto a conducting grating contains light rays corresponding to different surface plasmon resonance conditions, and has a beam shape, such as an annular beam shape or a linear beam shape as described above, that causes a reflected light beam produced by the conducting grating reflecting the light beam emitted onto the conducting grating to contain light rays corresponding to different surface plasmon resonance conditions.

Although a few embodiments in accordance with the invention have been shown and described, it would be appreciated by those skilled in the art that changes may be made in these embodiments without departing from the principles and spirit of the invention, the scope of which is defined in the claims and their equivalents.

What is claimed is:

1. A surface plasmon resonance apparatus comprising:
a conducting grating; and
a light beam source operable to emit a light beam onto the conducting grating;
wherein the conducting grating reflects the light beam emitted onto the conducting grating to produce a reflected light beam; and
wherein the light beam emitted onto the conducting grating has a beam shape that causes the reflected light beam to contain reflected light rays corresponding to different surface plasmon resonance conditions.

2. The apparatus of claim 1, wherein a perpendicular projection of one of the reflected light rays onto an imaginary plane contacting the conducting grating coincides with an axis lying in the imaginary plane, the axis corresponding to an azimuthal angle of zero; and
wherein perpendicular projections of other ones of the reflected light rays onto the imaginary plane coincide with other lines lying in the imaginary plane, the other lines being rotated from the axis by different azimuthal angles.

3. The apparatus of claim 1, wherein the conducting grating has grooves and has an actual periodicity measured along an axis that is perpendicular to the grooves, the axis lying in an imaginary plane contacting the conducting grating, the axis corresponding to an azimuthal angle of zero; and
wherein the different surface plasmon resonance conditions correspond to different effective periodicities of the conducting grating, the different effective periodicities being measured along different lines lying in the imaginary plane, the different lines being rotated from the axis by different azimuthal angles.

4. The apparatus of claim 3, wherein the different effective periodicities of the conducting grating are defined by the following equation:
$$Λ = \frac{{Λ}_{0}}{cos Ψ}$$
where Λ₀ is the actual periodicity of the conducting grating, Λ is an effective periodicity of the conducting grating measured along a line in the imaginary plane, the line being rotated from the axis by an azimuthal angle ψ, and an effective periodicity Λ measured at an azimuthal angle ψ=0° is equal to the actual periodicity Λ₀.

5. The apparatus of claim 1, wherein the apparatus is operable to analyze a sample;
wherein the conducting grating has a surface that contacts the sample during analysis of the sample, thereby forming a conducting grating/sample interface; and
wherein when the light beam source is operated to emit the light beam onto the conducting grating during the analysis of the sample, a light ray corresponding to a surface plasmon resonance condition for the sample in the light beam emitted onto the conducting grating generates surface plasmons that propagate along the conducting grating/sample interface in a direction of a line lying in an imaginary plane contacting the conducting grating that coincides with a perpendicular projection of the reflected light ray corresponding to the surface plasmon resonance condition for the sample onto the imaginary plane.

6. The apparatus of claim 5, wherein the generation of the surface plasmons reduces a reflectivity of the conducting grating for the reflected light ray corresponding to the surface plasmon resonance condition for the sample, thereby producing a reflectivity dip in the reflected light beam at a position of the reflected light ray corresponding to the surface plasmon resonance condition; and
wherein the apparatus further comprises a detector that detects the reflected light beam and generates a detection signal from which the reflectivity dip is detectable.

7. The apparatus of claim 6, wherein the detector sequentially detects portions of the reflected light beam.

8. The apparatus of claim 6, wherein the detector comprises a line sensor that detects an entirety of the reflected light beam at once.

9. The apparatus of claim 1, wherein the light beam is an annular light beam having an annular beam shape.

10. The apparatus of claim 9, wherein the conducting grating has linear grooves.

11. The apparatus of claim 9, wherein the conducting grating has curved grooves.

12. The apparatus of claim 1, wherein the light beam is a linear light beam having a linear beam shape.

13. The apparatus of claim 12, wherein the conducting grating has curved grooves.

14. A method of detecting a new surface plasmon resonance condition caused by a change in a sample, comprising:
placing a sample to be analyzed in contact with a conducting grating have a fixed actual periodicity to form a conducting grating/sample interface;
emitting a light beam having a fixed wavelength onto the conducting grating at a fixed incident angle relative to a normal to an imaginary plane contacting the conducting grating to generate surface plasmons at the conducting/grating sample interface under a surface plasmon resonance condition that changes to a new surface plasmon resonance condition if there is a change in the sample; and
detecting a new surface plasmon resonance condition caused by a change in the sample without changing an index of refraction of the conducting grating, without changing the wavelength of the light beam emitted onto the conducting grating, without changing the incident angle of the light beam emitted onto the conducting grating, and without changing the actual periodicity of the conducting grating.

15. The method of claim 14, wherein the conducting grating has grooves;
wherein the actual periodicity of the conducting grating is measured along an axis that is perpendicular to the grooves, the axis lying in an imaginary plane contacting the conducting grating, the axis corresponding to an azimuthal angle of zero;
wherein the change in the sample causes the surface plasmon resonance condition to change to the new surface plasmon resonance condition within a range of different surface plasmon resonance conditions corresponding to a range of different effective periodicities of the conducting grating; and
wherein the different effective periodicities of the conducting grating are measured along different lines lying in the imaginary plane, the different lines being rotated from the axis by different azimuthal angles.

16. The method of claim 15, wherein the conducting grating reflects the light beam emitted onto the conducting grating to produce a reflected light beam; and
wherein the light beam emitted onto the conducting grating has a beam shape that causes the reflected light beam to contain reflected light rays corresponding to the different surface plasmon resonance conditions.

17. The apparatus of claim 16, wherein the different effective periodicities of the conducting grating are defined by the following equation:
$$Λ = \frac{{Λ}_{0}}{cos Ψ}$$
where Λ₀ is the actual periodicity of the conducting grating, Λ is an effective periodicity of the conducting grating measured along a line in the imaginary plane, the line being rotated from the axis by an azimuthal angle ψ, and an effective periodicity Λ measured at an azimuthal angle ψ=0° is equal to the actual periodicity Λ₀.

18. The method of claim 14, wherein the change in the sample causes a change in an index of refraction of the sample; and
wherein the change in the index of refraction of the sample causes the surface plasmon resonance condition to change to the new surface plasmon resonance condition.

19. A method of increasing a detection sensitivity of a surface plasmon resonance apparatus, the apparatus comprising
a light source operable to emit a light beam having a fixed wavelength,
a conducting grating having a fixed actual periodicity that reflects a light beam emitted onto the conducting grating to produce a reflected light beam, and
a detector operable to detect the reflected light beam and generate a detection signal representative of the detected reflected light beam,
the method comprising:
operating the light source to emit the light beam having the fixed wavelength;
shaping the light beam emitted from the light source to produce a shaped light beam having a beam shape containing light rays corresponding to different surface plasmon resonance conditions;
emitting the shaped light beam onto the conducting grating at an incident angle relative to a normal to an imaginary plane contacting the conducting grating to generate surface plasmons at a surface of the conducting grating under a surface plasmon resonance condition corresponding to one of the light rays in the shaped light beam, the conducting grating reflecting the shaped light beam emitted onto the conducting grating to produce a reflected light beam, the beam shape of the shaped light beam emitted onto the conducting grating causing the reflected light beam to contain reflected light rays corresponding to the different surface plasmon resonance conditions, the reflected light rays having different azimuthal angles when viewed in a direction perpendicular to the imaginary plane contacting the conducting grating, the different azimuthal angles being measured relative to an axis lying in the imaginary plane contacting the conducting grating, the axis corresponding to an azimuthal angle of zero, the reflected light rays including a reflected light ray corresponding to the surface plasmon resonance condition under which the surface plasmons are being generated and producing a reflectivity dip in the reflected light beam;
keeping the incident angle at which the shaped light beam is emitted onto the conducting grating fixed;
operating the detector to detect the reflected light beam;
detecting a position of the reflectivity dip in the reflected light beam based on the detection signal generated by the detector; and
determining the azimuthal angle of the reflected light ray corresponding to the surface plasmon resonance condition under which the surface plasmons are being generated based on the detected position of the reflectivity dip in the reflected light beam.

20. The method of claim 19, wherein the conducting grating has grooves;
wherein the axis lying in the imaginary plane contacting the conducting grating and corresponding to an azimuthal angle of zero is perpendicular to the grooves of the conducting grating;
wherein the conducting grating has an actual periodicity measured perpendicular to the grooves along the axis corresponding to the azimuthal angle of zero; and
wherein the different surface plasmon resonance conditions correspond to different effective periodicities of the conducting grating, the different effective periodicities being measured along different lines lying in the imaginary plane contacting the conducting grating, the different lines being rotated from the axis corresponding to the azimuthal angle of zero by different azimuthal angles.
